(19) United States
(12) Patent Application Publication
(10) Pub. No.: US 2002/0104823 A1
(43) Pub. Date: Aug. 8, 2002

(54) Fabrication integration of micro-components

(76) Inventors: Shawn J. Cunningham, Colorado Springs, CO (US); Dana R. DeReus, Colorado Springs, CO (US); Arthur S. Morris, Raleigh, NC (US)

Correspondence Address: JENKINS & WILSON, PA, 3100 TOWER BLVD, SUITE 1400, DURHAM, NC, 27707, US

(21) Appl. No.: 10/041,696

(22) Filed: Jan. 8, 2002

Related U.S. Application Data
(60) Provisional application No. 60/260,558, filed on Jan. 9, 2001.

(51) Int. Cl. B29D 11/00; G02B 6/12

(52) U.S. Cl. 216/24; 385/14

(57) ABSTRACT

Fabrication Integration of Micro-Components. A method for manufacturing a first and second micro-component on a surface of a substrate, including fabricating a first and second constraint structure. The first and second constraint structures are substantially formed to fit a surface of the first and second micro-component, respectively, for positioning the first and second micro-components with respect to each other. The method includes fabricating the first and second micro-components in separate processes. The first and second micro-components have a surface substantially formed to fit the first and second constraint structures, respectively.

### CROSS-REFERENCE TO RELATED APPLICATION

This nonprovisional application claims the benefit of U.S. Provisional Application No. 60/260,558, filed Jan. 9, 2001, the disclosure of which is incorporated by reference herein in its entirety.

### TECHNICAL FIELD

The present invention relates to micro-components. More particularly, the present invention relates to the assembly and fabrication of micro-components on a substrate.

### BACKGROUND ART

In communication networks, optical transmission systems are often used for the transmission of data signals between network terminals such as telephones or computers. Optical transmission systems transmit data signals via data-encoded light through fiber optics. Many functions in optical switching systems require physical interaction with the light output from “incoming” fiber optics. Among the functions requiring light interaction are redirecting light from one fiber optic to another, shuttering light, filtering light, converting light output to electrical form, and dividing light into certain wavelengths.

In optical transmission systems, micro-electro-mechanical systems (MEMS) devices and other micro-components are typically used to physically interact with transmitted light. For example, micro-components, such as lenses and wavelength dividers/multiplexors, can be used in combination with an optical MEMS device, such as an array of shutters, to filter or redirect certain wavelengths of light from “incoming” fiber optics. These devices are manufactured with lithographic mass fabrication techniques of the kind that are used by the semiconductor industry in the manufacture of silicon integrated circuits. Generally, the technology involves shaping a multilayer structure by sequentially depositing and shaping layers of a multilayer wafer that typically includes a plurality of polysilicon layers that are separated by layers of silicon oxide and silicon nitride. Typically, individual layers are shaped by a process known as etching. The etching process is generally controlled by masks that are patterned by photolithographic techniques. MEMS technology can also involve the etching of intermediate sacrificial layers of the wafer to release overlying layers for use as thin elements that can be easily deformed or moved to function as an actuator.

The minimization of the tolerances between micro-components that interact with each other is important for many applications, such as optical micro-components in optical switching systems. The accurate positioning of micro-components with respect to one another serves to minimize tolerances. The positioning of a micro-component with respect to another micro-component on a substrate includes the six degrees of freedom of the micro-component with respect to the substrate. The tolerances between devices manufactured together in a single fabrication process can be less than 2 microns. Oftentimes, those micro-components that interact with each other must be fabricated in separate processes due to the incompatibility of one or more steps employed in the fabrication of each micro-component. The fabrication of some micro-components can be incompatible with each other when, for example, the materials and process required to fabricate a component is detrimental to the form, fit, and function of another micro-component. Furthermore, certain processes for fabrication of a micro-component may not be able to create the desired geometries of another micro-component. For example, a surface micro-machining process is inherently only able to produce components with low aspect ratios of out-of-plane thickness to planar dimensions and is not able to produce micro-components with high aspect ratios. In the case of incompatible fabrication processes, the two micro-components must be individually fabricated or assembled in first or second level packaging. Micro-components assembled in this fashion typically have assembly tolerances of 25 microns or greater. Such assembly tolerances are unacceptable for many optical switching systems.

Adaptive alignment can be employed in the assembly of discretely fabricated micro-components to improve the tolerances of micro-components. In adaptive alignment, micro-components are placed relative to each other in a real-time fashion wherein feedback parameter, such as signal intensity or signal loss, are maximized or minimized to meet required specifications. In adaptive alignment, an optical signal is introduced into the assembly process. The optical signal is incident upon the micro-component being assembled and subsequently reflected or transmitted to a detector. The position of the micro-component is adjusted until the feedback parameter indicates that the position of the micro-component position is optimized. Once the micro-component is optimally positioned, it is fixed in the position on the substrate. Adaptive alignment techniques are non-value added functions in an assembly process requiring hardware, software, and test time.

Therefore, it is desired to improve the manufacture and accuracy of the positioning of micro-components with respect to one another. It is also desired to increase the efficiency of the fabrication of these micro-components, such as eliminating or minimizing the need for adaptive alignment techniques.

### DISCLOSURE OF THE INVENTION

According to one aspect of the present invention, a method is provided for manufacturing a first and second micro-component on a surface of a substrate. The method includes fabricating a first and second constraint structure on the surface of the substrate. The first and second constraint structures are substantially formed to fit at least a portion of a surface of the first and second micro-components, respectively, for positioning the first and second micro-components with respect to each other. Furthermore, the method includes fabricating the first and second micro-components. The first and second micro-components have a surface substantially formed to fit the first and second constraint structures, respectively. The method further includes attaching at least a portion of the surface of the first micro-component to the first constraint structure and attaching at least a portion of the surface of the second micro-component to the second constraint structure.

According to a second aspect of the present invention, a substrate having a surface for manufacturing a first and second micro-component thereto is provided. The substrate includes a plurality of constraint structures formed on the surface of the substrate for positioning at least the first and second micro-component on the substrate. The first and second constraint structures are substantially formed to fit at least a portion of a surface of the first and second micro-component. The first and second micro-component each attached to a separate constraint structure.

Accordingly, it is an object of the present invention to provide an improved method of manufacture of micro-components that have fabrication steps that are incompatible with each other.

It is another object of the present invention to improve the tolerances between micro-components that have fabrication steps incompatible with each other.

Some of the objects of the invention having been stated hereinabove and which are achieved in whole or in part by the present invention, other objects will become evident as the description proceeds when taken in connection with the accompanying drawings as best described hereinbelow.

### BRIEF DESCRIPTION OF THE DRAWINGS

Exemplary embodiments of the invention will now be explained with reference to the accompanying drawings, of which:

FIG. 1 is a schematic view of a discretely assembled MEMS device and micro-optic device combination representing the lowest level of micro-component integration on a first level package as known to those of skill in the art;

FIGS. 2A and 2B are a schematic cross-sectional side view and schematic top view, respectively, of an exemplary integrated device including a MEMS device integrated with lenses;

FIGS. 3A and 3B are a schematic cross-sectional side view and a schematic top view, respectively, of a substrate and constraint slots;

FIGS. 4A and 4B are a schematic cross-sectional side view and a schematic top view, respectively, of the result of a step in the fabrication of an integrated device;

FIG. 5 is schematic of an integrated device fabricated on a substrate surface;

FIGS. 6A and 6B are schematic cross-sectional side and a schematic top views, respectively, of another exemplary integrated device including a MEMS device;

FIGS. 7A and 7B are schematic cross-sectional side and schematic top views, respectively, of a substrate and constraint slots;

FIG. 8 is a schematic of an integrated device fabricated on a substrate surface;

FIGS. 9A and 9B are schematic cross-section side and schematic top views, respectively, of another exemplary integrated device including a planar lens;

FIG. 10 is a schematic of an integrated device fabricated on a surface of a substrate;

FIG. 11 is a schematic of another integrated device fabricated on a surface of a substrate; and

FIG. 12 is a flow chart illustration of a fabrication process summary in accordance with an embodiment of the present invention.

### DETAILED DESCRIPTION OF THE INVENTION

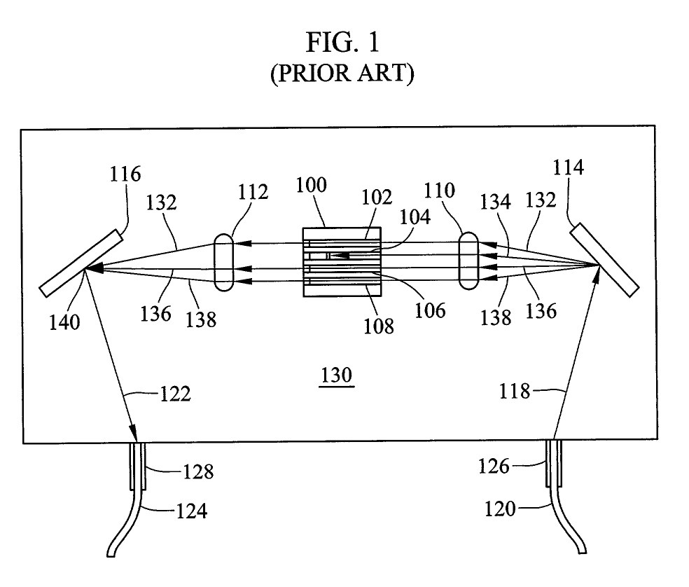

The fabrication method of the present invention integrates processes for fabricating two or more micro-components into a single fabrication process to improve tolerance levels. Referring to FIG. 1, a schematic view of a discretely assembled optical MEMS device and micro-optic device combination is illustrated to represent the lowest level of micro-component integration. This package includes a MEMS device 100 having an array of shutters 102,104,106, and 108 in combination with lenses 110 and 112, wavelength divider 114, and wavelength multiplexor 116 for blocking certain wavelengths of light included in a light beam 118 directed from an “incoming” fiber optic 120 and transmitting the resulting light beam 122 to an “outgoing” fiber optic 124. Fiber-in package 126 and fiber-out package 128 are fabricated on substrate surface 130 for attaching fiber optic 120 and fiber optic 124, respectively. MEMS device 100, lenses 110 and 112, wavelength divider 114, and wavelength multiplexor 116 are also discretely fabricated and assembled on substrate surface 130. This assembly of discrete components represents the lowest level of integration. In alternate embodiments, other micro-components that can be assembled in this fashion are filters, prisms, polarizers, lasers, diodes, and other micro-components as known to those of skill in the art.

Light beam 118 output from fiber optic 120 is directed to a wavelength divider 114, which spreads out incoming light beam 118 into a continuum of four light components 132, 134, 136, and 138 according to wavelength. Light components 132, 134,136, and 138 are directed by lens 110 to shutters 102, 104, 106, and 108, respectively. In another embodiment, the function of lens 110 can be performed by a prism, grating or another suitable micro-component known to those of skill in the art. Shutters 102, 104, 106, and 108 can be actuated to block light components 132, 134, 136, and 138, respectively. As shown, light component 134 is blocked by shutter 104. Alternatively, shutters 102, 104, 106, and 108 can be used to interrupt, reflect, redirect, filter, or otherwise interact with light components 132,134,136, and 138. Alternatively, another type MEMS device can be used to interact with light components 132, 134,136, and 138. Unblocked light components 132,136, and 138 pass shutters 102, 104, and 108, respectively, to lens 112. Lens 112 focuses remaining light components 132, 136, and 138 to a single position 140 on wavelength multiplexor 116 for redirection as a single light beam 122 combination of light components 132, 136, and 138 to “outgoing” fiber optic 124. As stated above, the assembly tolerances of such discretely fabricated micro-components can exceed 25 microns.

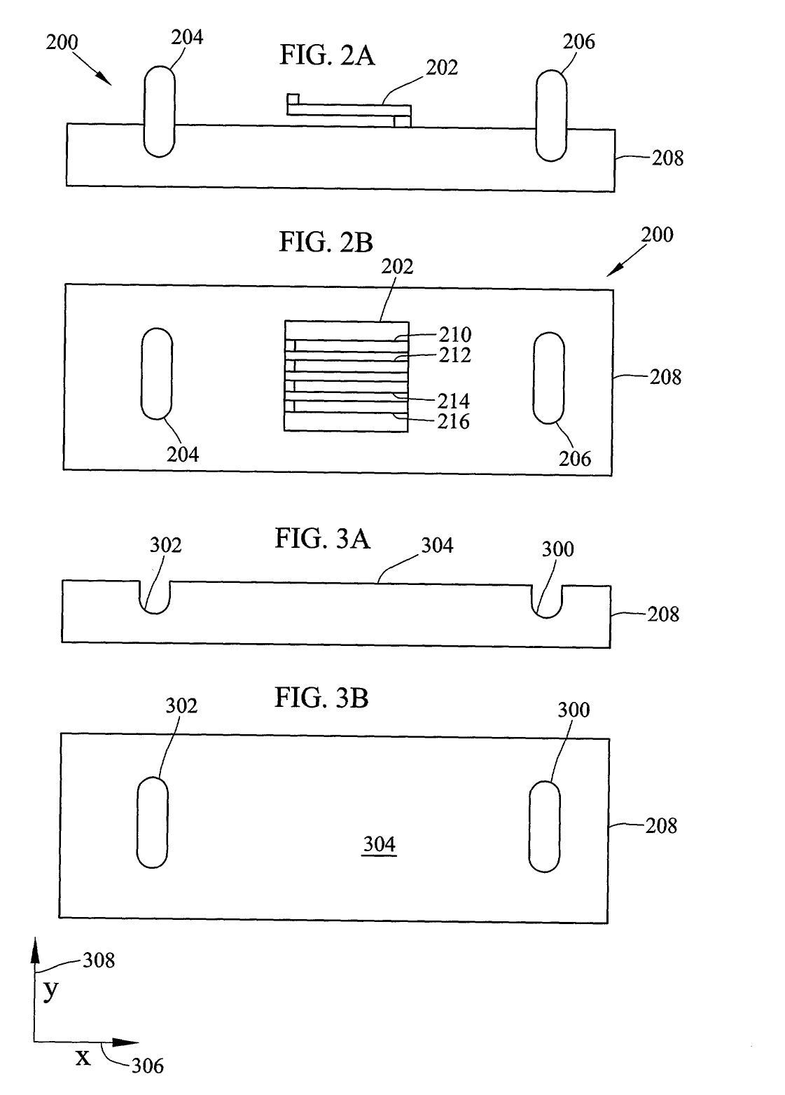

The present invention integrates at least one step in the fabrication process of a first component with at least one step in the fabrication process of a second component that has fabrication steps that are incompatible with the first micro-component. This fabrication process serves to minimize the tolerances between incompatible micro-components that interact with each other. Referring to FIGS. 2A and 2B, an illustration of a schematic cross-sectional side view and a schematic top view, respectively, is provided of an exemplary integrated device, generally designated 200, including a MEMS device 202 integrated with lenses 204 and 206. MEMS device 202 is fabricated on a surface portion of substrate 208 and positioned for proper interaction with lenses 204 and 206 fabricated on other surface portions of substrate 208 proximate to the portion on which MEMS device 202 is fabricated. MEMS device 202 is an array of shutters 210,212,214, and 216, as shown in FIG. 2B. Alternatively, MEMS device 202 and lenses 204 and 206 can be another suitable micro-component known to those of skill in the art.

In operation, lens 206 directs component light from a wavelength divider (not shown) along a pathway parallel to the surface of substrate 208 to shutters 210, 212, 214, and 216 for interaction. The component light passing shutters 210, 212, 214, and 216 continue to lens 204 where the light is focused to another micro-component (not shown). Lenses 204 and 206 and MEMS device 202 are positioned with respect to each other within acceptable tolerances in an integrated fabrication process as described below in accordance with the present invention.

The process for forming integrated device 200 in the example of FIGS. 2A and 2B are shown in FIGS. 3A-5 and described hereinafter. Referring to FIGS. 3A and 3B, an illustration of a schematic cross-sectional side view and a schematic top view, respectively, is provided of substrate 208 and constraint slots 300 and 302. Constraint slots 300 and 302 are fabricated in surface 304 of substrate 208 by MEMS fabrication processes. Substrate 208 is manufactured of silicon in this embodiment. Constraint slots 300 and 302 can be fabricated using an etching or ablating process. Etching is typically performed with wet chemical etchants or dry etchants along with a patterned mask for selective removal of material. In the etching process, multiple constraint slots can be created at the same time with the relative position to one another being controlled by the patterned mask which is aligned to an alignment marks, or other such reference feature known to those of skill in the art, on substrate 208. The etching process can be performed in an isotropic or non-isotropic fashion. In an ablative process, material is removed and patterned by means such as a computer controlled laser or another process known to those of skill in the art. Since substrate 208 is silicon in this embodiment, constraint slots 300 and 302 can be manufactured in substrate 208 by anisotropic etching in suitable etchants, such as potassium hydroxide (KOH), ethylenediamine pyrochatechol (EDP), and tetramethyl ammonium hydroxide (TMAH) solutions. Alternatively, constraint slots 300 and 302 can be formed by a deep reactive ion etch (DRIE).

Constraint slots 300 and 302 serve as constraint structures integrated into the fabrication process for accurately positioning lenses 204 and 206 with respect to each other on substrate surface 304. Constraint structures are formed to fit a surface of a micro-component for positioning the micro-component with respect to another micro-component. Furthermore, the associated micro-component that is positioned on a constraint structure has a surface formed to fit the constraint structure. As described hereinafter, lenses 204 and 206 are placed in a fitted position within constraint slots 300 and 302, respectively. The positions of lenses 204 and 206 are controlled with respect to each other due to the formation of constraint slots 300 and 302 from the same mask in the MEMS photolithography process. Due to the photolithography process, constraint slots 300 and 302 can be positioned with respect to each other within a tolerance of 0.25 to 0.5 microns. Constraint slots 300 and 302 constrain the position of later assembled lenses 204 and 206 with respect to each other in all six degrees of freedom, including any direction parallel to substrate surface 304, a direction perpendicular to substrate surface 304, and all three angles of positioning with respect to each other. The depth of constraint slots 300 and 302 constrains the positions of lenses 204 and 206 with respect to each other in a direction perpendicular to substrate surface 304.

Alternatively, it is envisioned according to this invention that other suitable another constraint structures can be employed in the fabrication process for accurately positioning lenses 204 and 206 with respect to each other. For example, a structure can be fabricated on substrate surface 304 or a recess therein for use in positioning and constraining lenses 204 and 206 with respect to each other. For example, a structure can be fabricated on a substrate surface to protrude from the substrate surface or fabricated in recessed portion of substrate surface for fitting and constraining a micro-component. In order to constrain a rectangular component for example, a constraint slot shaped as a rectangle can be used to restrain the component. Alternatively, an assembly of four cylinder-shaped structures can be formed on a substrate surface for constraining a rectangular-shaped micro-component whose perimeter is defined by the positioning of the cylinder-shaped structures on the substrate. Other types of constraint structures can be formed on a substrate to fit and position a micro-component assembled thereon to other micro-components.

As described above, substrate 208 is manufactured of silicon in this embodiment. Alternatively, substrate 208 can be manufactured of any suitable material known to those of skill in the art for fabricating MEMS device 202 and lenses 204 and 206 thereto. Constraint slots 300 and 302 are etched on separate portions of a surface 304 of substrate 208. Alternatively, constraint slots 300 and 302 can be formed by another process known to those of skill in the art that is compatible with the fabrication of MEMS device 202. Referring now to FIG. 3B, constraint slots 300 and 302 constrain the rotational tolerance and the translational tolerances in directions x 306 and y 308 (directions parallel to substrate surface 304) between later fabricated lenses 204 and 206 and MEMS device 202 (as illustrated in FIGS. 2A and 2B).

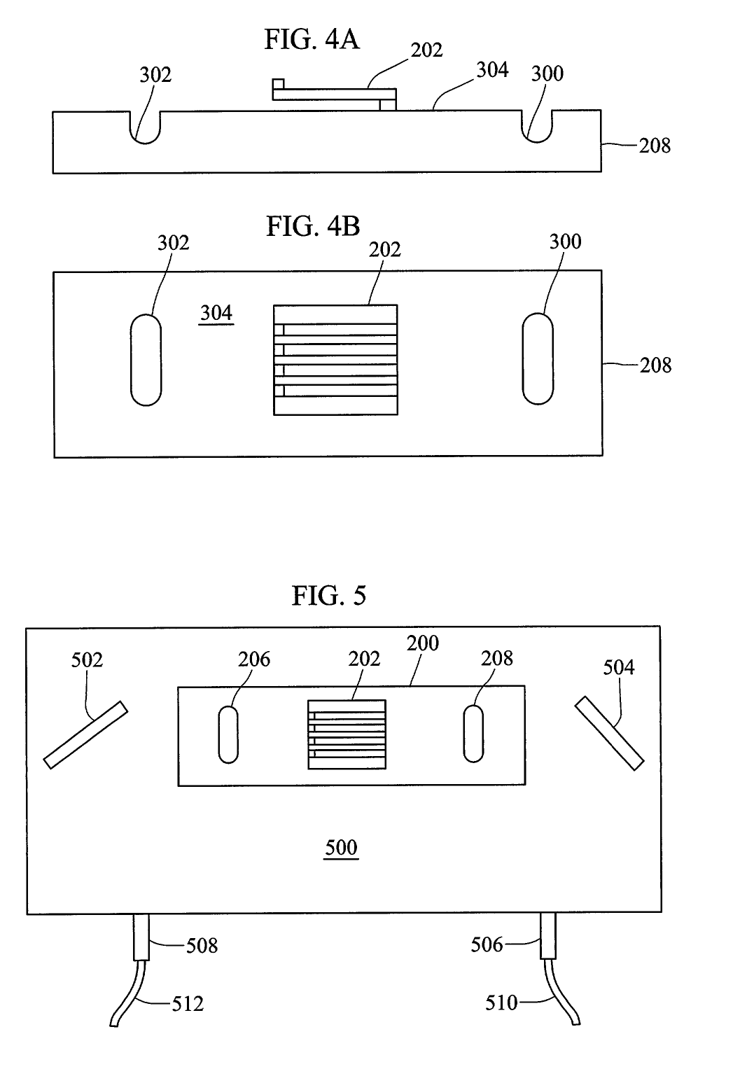

Referring now to FIGS. 4A and 4B, an illustration of a schematic cross-sectional side view and a schematic top view, respectively, is provided of the result of a step in the fabrication of integrated device 200, shown in FIGS. 2A and 2B. During the fabrication of constraint slots 300 and 302, alignment marks (not shown) are fabricated on surface 304 for indicating a position for placement of MEMS device 202 with respect to lenses 204 and 206. The fabrication of MEMS device 202 is positioned accurately by positioning the photolithography masks of MEMS device 202 to the alignment marks (not shown) fabricated during the fabrication process of constraint slots 300 and 302. Furthermore, during the fabrication of MEMS device 202, constraint slots 300 and 302 should be provided any necessary protection from damage resulting from fabrication of MEMS device 202. In general, the constraint slots 300 and 302 can be protected by the masking material during the MEMS fabrication process. Alternatively, the MEMS device 202 needs the protection of the masking layers during fabrication of constraint slots 300 and 302 when the MEMS device 202 is fabricated before the constraint slots 300 and 302. The MEMS device 202 and constraint 300 and 302 can also be protected by any other method known to those of skill in the art. The tolerance between MEMS device 202 and later fabricated lenses 204 and 206 is less than 2 microns due to the fabrication of constraint slots 300 and 302 and alignment marks in the same fabrication process.

After fabrication of MEMS device 202 on surface 304, lenses 204 and 206 are manufactured in a separate fabrication process. Lenses 204 and 206 are fabricated beginning with a glass material with a specific index of refraction. Lenses 204 and 206 are grinded and polished into a convex face. Alternatively, lenses 204 and 206 can have a concave face and have any suitable shape or size as known to those of skill in the art.

As necessary, MEMS device 202 is provided protection from the fabrication process, such as with packaging. Lenses 204 and 206 are then manually assembled and fitted in constraint slots 300 and 302 using optical epoxy. Alternatively, lenses 204 and 206 or other micro-components can be assembled via another suitable method such as epoxy adhesive, solder assembly, or another method known to those of skill in the art. Constraint slots 300 and 302 are shaped for fitting and constraining lenses 204 and 206, respectively, in a desired position.

Referring to FIG. 5, a schematic of an integrated device 200, shown in FIGS. 2A and 2B, bonded to a substrate surface 500 is illustrated. Wavelength multiplexor 502 and wavelength divider 504 are discretely fabricated and attached on substrate surface 500 for interaction with shutter 202 and lenses 204 and 206 of integrated device 200. Furthermore, a fiber-in package 506 and a fiber-out package 508 are fabricated on substrate surface 500 for attaching “incoming” fiber optic 510 and “outgoing” fiber optic 512, respectively. Integrated device 200, wavelength multiplexor 502, and wavelength divider 504 are attached to substrate 500 by bonding in this embodiment. Alternatively, integrated device 200, wavelength multiplexor 502, and wavelength divider 504 can be attached to substrate 500 by welding or another suitable method known to those of skill in the art. Integrated device 200, wavelength multiplexor 502, and wavelength divider 504 are placed with respect to each other using an active alignment method. Alternatively, integrated device 200, wavelength multiplexor 502, and wavelength divider 504 can be placed with respect to an alignment mark on substrate 500 such as a physical constraining feature.

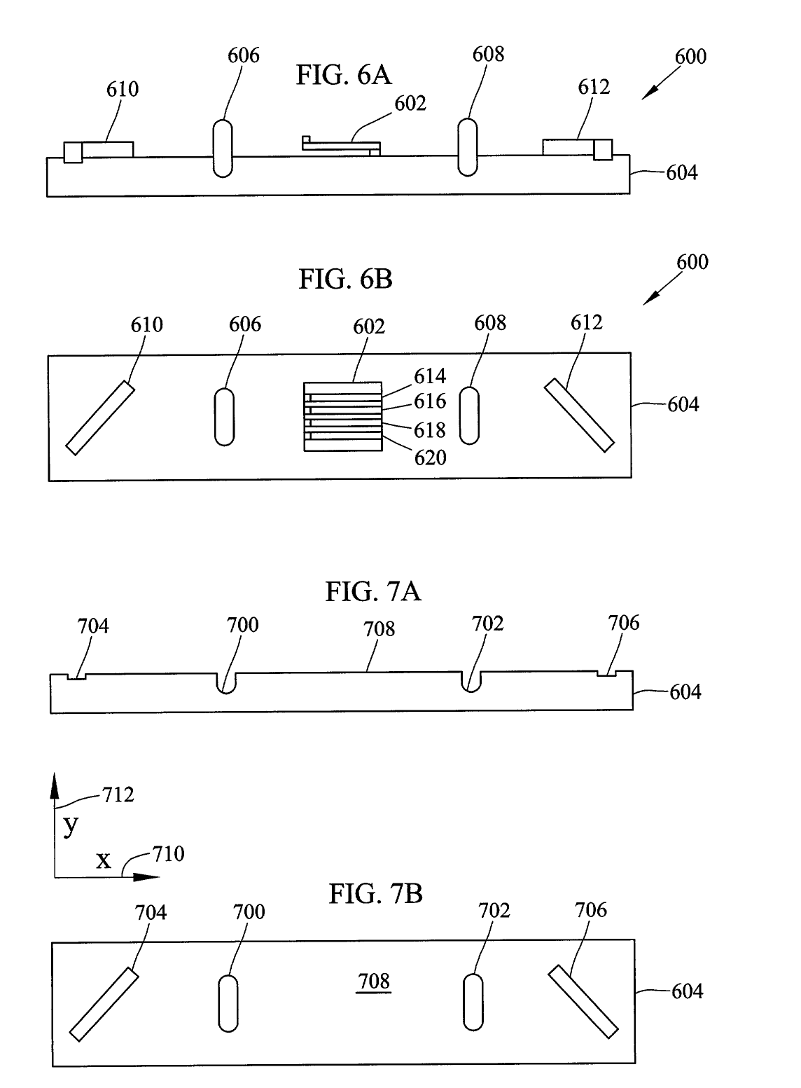

Another level of integration can be achieved by adding additional constraint structures to a substrate. Referring to FIGS. 6A and 6B, an illustration is provided of a schematic cross-sectional side view and a schematic top view, respectively, of another exemplary integrated device, generally designated 600, including a MEMS device 602 fabricated on a portion of substrate 604 and positioned for proper interaction with lenses 606 and 608, wavelength multiplexor 610, and wavelength divider 612 fabricated on other portions on the substrate proximate to MEMS device 602. In this embodiment, MEMS device 602 is an array of shutters 614, 616, 618, and 620. Alternatively, MEMS device 602 can be any other suitable MEMS device known to those of skill in the art. In operation, an “incoming” light beam from a fiber optic (not shown) is directed to wavelength divider 612, which divides the “incoming” light beam into four light components according to wavelength. Light components are directed by lens 608 to corresponding shutters 614, 616, 618, and 620 for interaction. The component light passing shutters 614, 616, 618, and 620 continues to lens 606 which focuses the light components to a single position on wavelength multiplexor 610. Those light components focused on wavelength multiplexor 610 are redirected as a single light beam to an “outgoing” fiber optic (not shown). Lenses 606 and 608, MEMS device 602, wavelength multiplexor 610, and wavelength divider 612 are positioned relative to each other within acceptable tolerances in an integrated fabrication process as described above in accordance with the present invention.

The processes for forming such an integrated device, generally designated 600, in the example of FIGS. 6A and 6B are shown in FIGS. 7A and 7B and described hereinafter. Referring to FIGS. 7A and 7B, an illustration is provided of a schematic cross-sectional side view and a schematic top view, respectively, of substrate 604 and constraint slots 700, 702, 704, and 706. Constraint slots 700 and 702 are elliptically shaped and sized to fit elliptically-shaped lenses 606 and 608, respectively. Similarly, constraint slots 704 and 706 are rectangularly shaped and sized to fit rectangular-shaped wavelength multiplexor 610 and wavelength divider 612, respectively. Referring now to FIG. 7B, constraint slots 700, 702, 704, and 706 constrain the rotational tolerance and the translation tolerances in direction x 710 and y 712 (directions parallel to surface 708) between later fabricated lenses 606 and 608 and MEMS device 602 (as illustrated in FIGS. 6A and 6B). As described before, alignment marks are fabricated during the fabrication of constraint slots 700, 702, 704, and 706 in order to position MEMS device 602.

Substrate 604 is manufactured of silicon in this embodiment. Alternatively, substrate 604 can be manufactured of any suitable material known to those of skill in the art. Substrate 604 is provided for fabricating constraint slots 700,702, 704, and 706 on portions of a surface 708 of substrate 604 as described above.

After fabrication of constraint slots 700, 702, 704, and 706 on surface 708, they are provided necessary protection during the fabrication of MEMS device 602. Alignment marks serve to position MEMS device 602 for fabrication on substrate 604. Next, lenses 606 and 608, wavelength multiplexor 610, and wavelength divider 612 are fabricated in separate fabrication processes and subsequently assembled into position in constraint slots 700, 702, 704, and 708, respectively.

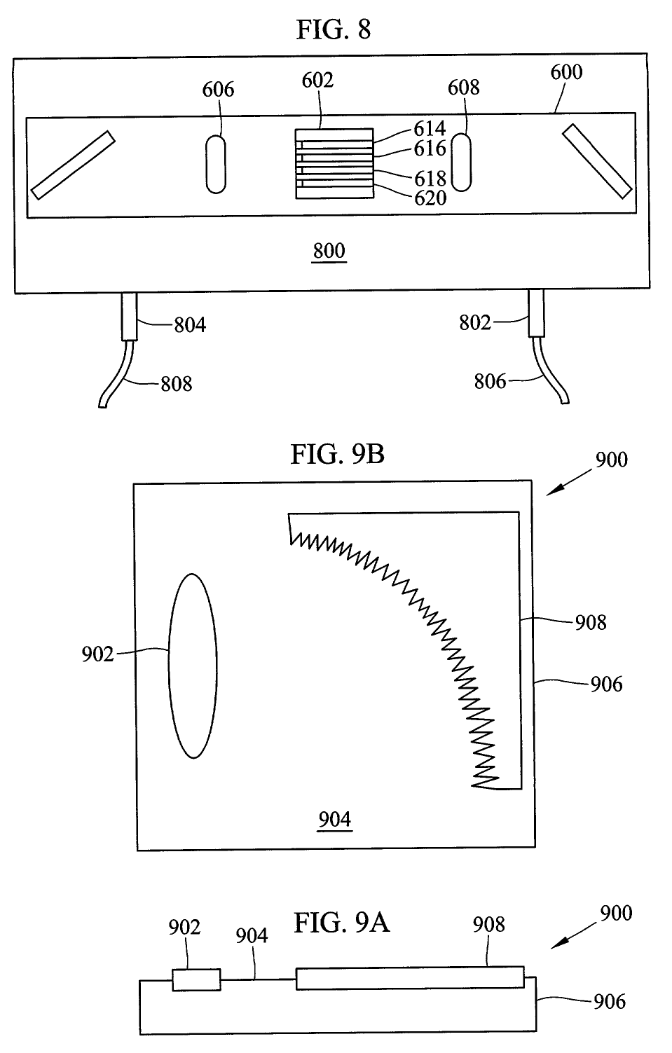

Referring to FIG. 8, a schematic of an integrated device 600 fabricated on a substrate surface 800 is illustrated. Fiber-in package 802 and a fiber-out package 804 are discretely fabricated on substrate surface 800 for attaching “incoming” fiber optic 806 and “outgoing” fiber optic 808, respectively. The process described above serves to minimize tolerances between the micro-components assembled on integrated device 600. Tolerances between those micro-components on integrated device 600 and fiber-in package 802 and a fiber-out package 804 are that of a typical assembly process.

As described in the above examples, a MEMS device is described manufactured in a fabrication process integrated with other process incompatible micro-components. Alternatively, the fabrication process of two or more MEMS device can be integrated with one another by providing alignment marks for each in a fabrication process. In certain instances, micro-components cannot be integrated with certain MEMS device due to limited compatibility between the fabrication processes for each. In these instances, certain steps in the fabrication process of each of the micro-components can be integrated with one another to improve tolerances between them. Referring to FIGS. 9A and 9B, an illustration of a schematic cross-section side view and a schematic top view, respectively, is provided of another exemplary integrated device, generally designated 900, including a planar lens 902 fabricated on a portion of a surface 904 of substrate 906 and positioned for proper interaction with planar grating 908 fabricated on another portion on substrate surface 904 proximate to planar lens 902. In operation, a light beam from an “incoming” fiber optic (not shown) is directed to planar grating 908, which disperses the light beam to a planar lens 902. Planar lens 902 focuses light components to a MEMS device having an array of shutters (not shown). Planar lens 902 and planar grating 908 are positioned relative to each other within acceptable tolerances in an integrated fabrication process as described above in accordance with the present invention.

Planar lens 902 and planar grating 908 are fabricated in the same fabrication process on substrate 906. Substrate 906 is manufactured of silicon in this embodiment. Alternatively, substrate 906 can be any suitable material known to those of skill in the art for fabrication with constraint slots 1000 and 1002. In the same fabrication process, planar lens 902 and planar grating 908 are fabricated from an oxide layer. Alternatively, a polymer layer with the suitable optical properties can be used as known to those of skill in the art. Planar lens 902 can also be fabricated using an RIE etch of silicon oxide (SiO₂) Furthermore, any suitable method known to those of skill in the art can be used to fabricate planar grating 908. The simultaneous fabrication of planar lens 902 and planar grating 908 reduce tolerances between each micro-components.

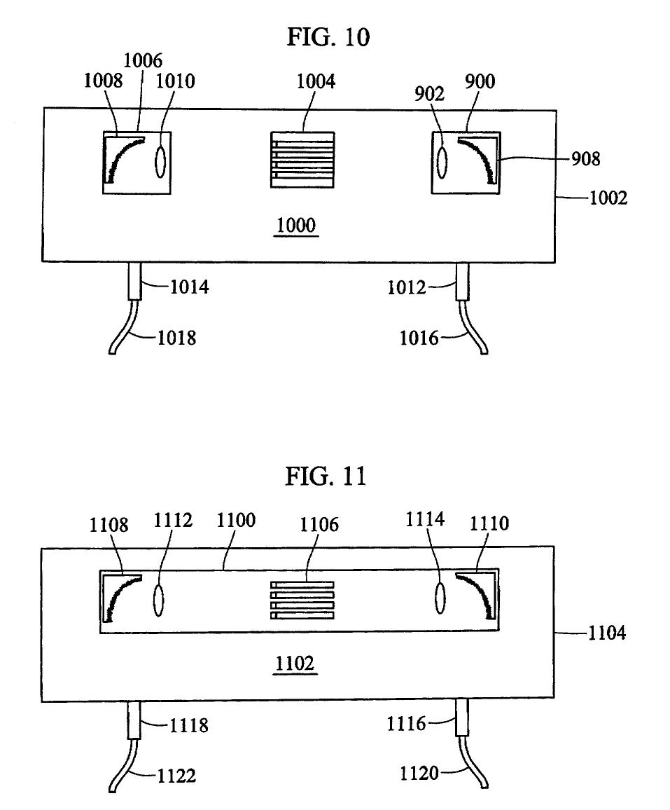

Referring to FIG. 10, a schematic of integrated device 900, as described above, bonded to a surface 1000 of a substrate 1002 is illustrated. A MEMS device 1004 having an array of shutters is discretely fabricated on substrate surface 1000 for interaction with the micro-components on integrated device 900. Furthermore, another integrated device 1006 including a planar grating 1008 and lens 1010 is bonded to substrate surface 1000 for interaction with other micro-components. A fiber-in package 1012 and a fiber-out package 1014 are fabricated on substrate surface 1000 for attaching “incoming” fiber optic 1016 and “outgoing” fiber optic 1018, respectively.

The micro-components of FIG. 10 can be integrated in order to improve assembly tolerance. Referring to FIG. 11, a schematic of an integrated device 1100 fabricated on a surface 1102 of a substrate 1104 is illustrated. Integrated device 1100 includes a MEMS device 1106 having an array of shutters, planar gratings 1108 and 1110, and lenses 1112 and 1114 for interaction with each other. Furthermore, a fiber-in package 1116 and a fiber-out package 1118 are fabricated on substrate surface 1102 for attaching “incoming” fiber optic 1120 and “outgoing” fiber optic 1122, respectively.

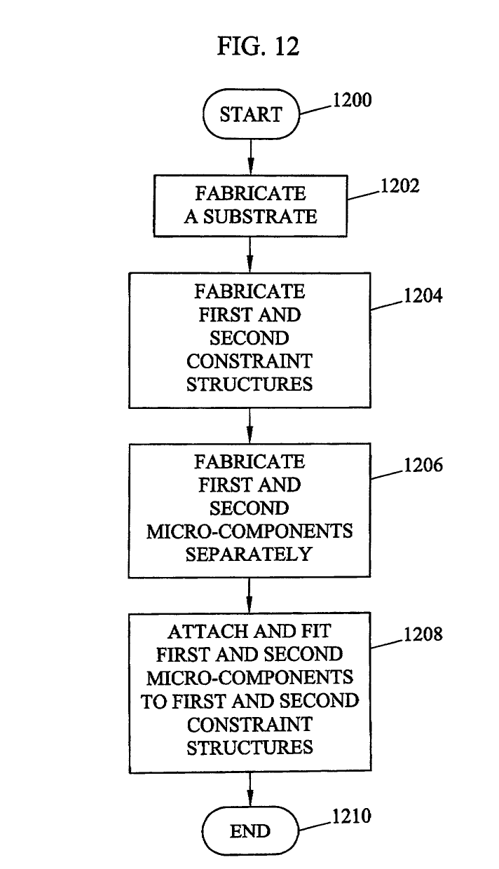

Referring to FIG. 12, a flow chart of a fabrication process summary is illustrated in accordance with an embodiment of the present invention. At step 1200, the process begins. Next, a substrate is a fabricated having a surface for assembling or fabricating micro-components (step 1202). A first and second constraint structure is then fabricated on different surfaces of the substrate for positioning a first and second micro-component, respectively (step 1204). At step 1206, the first and second micro-components are fabricated in separate fabrication processes. Each micro-component has a surface shaped to fit the constraint structures. In step 1208, the first and second micro-components are attached and fitted to the first and second constraint structures, respectively. Next, the process ends (step 1210). As described above, certain steps in the fabrication of the first and second micro-components are incompatible. In another fabrication process, the first micro-component is manufactured on the substrate and positioned by the constraint structure with respect to the second micro-component.

Thus, a method for integrating the fabrication processes of incompatible micro-components according to the present invention is provided. Although the present invention has been described with respect to optical MEMS devices and optical micro-components, the principles of the present invention also can be applied to other macro-components and any other type components that operate together. Furthermore, it will be understood that various details of the invention may be changed without departing from the scope of the invention. The foregoing description is for the purpose of illustration only, and not for the purpose of limitation—the invention being defined by the claims.

What is claimed is:

1. A method for manufacturing a first and second micro-component on a surface of a substrate, comprising:
(a) fabricating a first and second constraint structure on the surface of the substrate, the first and second constraint structures substantially formed to fit at least a portion of a surface of the first and second micro-component, respectively, for positioning the first and second micro-components with respect to each other;
(b) fabricating the first micro-component having a surface substantially formed to fit the first constraint structure;
(c) fabricating the second micro-component having a surface substantially formed to fit the second constraint structure;
(d) attaching at least a portion of the surface of the first micro-component to the first constraint structure; and
(e) attaching at least a portion of the surface of the second micro-component to the second constraint structure.

2. The method of claim 1 wherein the first and second micro-components are optical devices.

3. The method of claim 1 wherein fabricating the first constraint structure includes etching a slot in the surface of the substrate, the slot substantially formed to fit the at least a portion of the surface of the first micro-component.

4. The method of claim 1 wherein fabricating the second constraint structure includes etching a slot in the surface of the substrate, the slot substantially formed to fit the at least a portion of the surface of the second micro-component.

5. The method of claim 1 wherein fabricating the first and second constraint structures includes forming the first and second constraint structures in a photolithography fabrication process.

6. The method of claim 1 wherein fabricating the first constraint structure includes forming a protruding structure on the surface of the substrate being substantially formed to fit the at least a portion of the surface of the first micro-component.

7. The method of claim 1 wherein fabricating the second constraint structure includes forming a protruding structure on the surface of the substrate being substantially formed to fit the at least a portion of the surface of the second micro-component.

8. The method of claim 1 wherein the first and second constraint structures constrain the position of the first and second micro-components with respect to each other in directions parallel to the surface of the substrate.

9. The method of claim 1 wherein the first constraint structure constrains the position of the first micro-component with respect to the second micro-component in a direction perpendicular to the surface of the substrate.

10. The method of claim 1 wherein the second constraint structure constrains the position of the second micro-component with respect to the first micro-component in a direction perpendicular to the surface of the substrate.

11. The method of claim 1 wherein the first constraint structure constrains the position angle of the first micro-component with respect to the second micro-component.

12. The method of claim 1 wherein the second constraint structure constrains the position angle of the second micro-component with respect to the first micro-component.

13. A method for manufacturing a first and second micro-component on a surface of a substrate, comprising:
(a) fabricating a first and second constraint slot on the surface of the substrate, the first and second constraint slots being etched in the surface of the substrate and substantially formed to fit at least a portion of a surface of the first and second micro-component, respectively, for positioning the first and second micro-components with respect to each other;
(b) fabricating the first micro-component having a surface substantially formed to fit the first constraint slot;
(c) fabricating the second micro-component having a surface substantially formed to fit the second constraint slot;
(d) attaching at least a portion of the surface of the first micro-component to the first constraint structure; and
(e) attaching at least a portion of the surface of the second micro-component to the second constraint structure.

14. The method of claim 13 wherein fabricating the first and second constraint slots includes forming first and second constraint slots in a photolithography fabrication process.

15. A method for manufacturing a first and second micro-component on a surface of a substrate, comprising:
(a) fabricating a constraint structure and an alignment mark on the surface of the substrate, the constraint structure substantially formed to fit at least a portion of a surface of the first micro component for positioning the first micro-component with respect to the second micro-component, the alignment mark for indicating the positioning of the second micro-component;
(b) fabricating the second micro-component on the surface of the substrate, positioned by alignment with the alignment mark;
(c) fabricating the first micro-component having a surface substantially formed to fit the constraint structure; and
(d) attaching at least a portion of the surface of the first micro-component to the constraint structure.

16. The method of claim 15 wherein the first micro-component is an optical device.

17. The method of claim 15 wherein the second micro-component is a MEMS device.

18. The method of claim 17 wherein the MEMS device includes a shutter for interacting with light.

19. The method of claim 15 wherein fabricating the constraint structure includes etching a slot in the first surface portion substantially formed to fit and position the first micro-component with respect to the second micro-component.

20. The method of claim 15 wherein fabricating the constraint structure and alignment mark includes forming the constraint structure and alignment mark in a photolithography fabrication process.

21. The method of claim 15 wherein fabricating the constraint structure includes forming a structure on first surface portion that protrudes from the first surface portion being substantially formed to fit and position the first micro-component.

22. The method of claim 15 wherein the constraint structure and alignment mark constrains the position of the first and second micro-components with respect to each other in directions parallel to the surface of the substrate.

23. The method of claim 15 wherein the constraint structure constrains the position of the first micro-component with respect to the second micro-component in a direction perpendicular to the surface of the substrate.

24. The method of claim 15 wherein the constraint structure constrains the position angle of the first micro-component with respect to the second micro-component.

25. The method of claim 15 wherein fabricating the constraint structure includes forming a constraint slot in a photolithography fabrication process.

26. A substrate having a surface for manufacturing a first and second micro-component thereto, comprising:
(a) a plurality of constraint structures formed on the surface of the substrate for positioning at least the first and second micro-component on the substrate, the first and second constraint structures substantially formed to fit at least a portion of a surface of the first and second micro-component; and
(b) a first and second micro-component each attached to a separate constraint structure.
